(19) United States
(12) Patent Application Publication
(10) Pub. No.: US 2006/0129797 A1
(43) Pub. Date: Jun. 15, 2006

(54) Hardware-supported secure network boot

(75) Inventors: Glenn Durfee, San Francisco, CA (US); Dirk Balfanz, Redwood City, CA (US); Diana Kathryn Smetters, Belmont, CA (US); Paul Joseph Stewart, Sunnyvale, CA (US)

Correspondence Address: AXIOM LEGAL SOLUTIONS, C/O PORTFOLIOIP, P.O. BOX 52050, MINNEAPOLIS, MN, 55402, US

(73) Assignee: Palo Alto Research Center, Inc.

(21) Appl. No.: 11/012,513

(22) Filed: Dec. 15, 2004

(51) Int. Cl. G06F 9/24

(52) U.S. Cl. 713/2

(57) ABSTRACT

Systems and methods for establishing an authenticated and encrypted network connection in a boot protocol, and specifying the boot image to be loaded by a client, are disclosed. A hardware token or other portable medium, such as a USB drive or device, CD, mini-CD, or floppy diskette, is used to store authentication and/or identification information for a server. A client uses the information on the token to authenticate the network server upon initial connection to the network and request a boot image. Furthermore, the client and server may use the authentication information from the token to establish secure communications and mutually authenticate each other.

### TECHNICAL FIELD

This disclosure generally relates to electrical computers and digital processing systems, and in particular it relates to network computer configuration and initialization.

### BACKGROUND OF THE DISCLOSURE

Network boot protocols are often used by digital networked devices to request, receive, and execute diagnostic software, whole operating systems (OS), software upgrades, and other administration tools. There are several problems facing the way these protocols are used today. First, devices request and receive executable boot images from servers using an unauthenticated, unencrypted network connection, exposing the network to risk of intrusion by unauthorized parties. Second, for networks consisting of a heterogeneous collection of devices, a significant amount of complexity and time is involved to configure servers to deliver the correct boot image to the appropriate clients.

Secure network boot is a relatively unexplored area. One could cobble together a solution to these problems by setting up a wired network to which physical access was restricted, setting up devices to boot over the network, and checking that the correct boot image has been delivered upon boot (e.g. by visually comparing checksums). However, this would be an inordinately time-consuming approach.

Existing boot protocols such as Bootstrap Protocol (BOOTP) and Trivial File Transfer Protocol (TFTPBOOT) are designed to allow new machines, and machines without the ability to store local state information, to obtain boot or upgrade images over a network. Unfortunately, as they are designed to operate with “blank slate” client machines, they make no provisions for security, which is particularly critical during initialization of new clients on a network, and later when these protocols are used to replace or upgrade software. Providing a level of security at these stages would deter malicious man-in-the-middle attacks and the like, in which the identity of a client or server could be hijacked to fraudulently gain access to the network.

Accordingly, there is a need for a method and apparatus for performing a secure network boot that addresses certain deficiencies in existing technologies.

### SUMMARY OF THE DISCLOSURE

The present disclosure, therefore, introduces methods for securely configuring a network client on a computer network, in which authentication data for network boot services is stored on a hardware token or portable medium, such as a compact disc (CD), USB device, or floppy diskette. The portable medium is inserted in a new network client prior to initializing its connection to a computer network. The network client requests a boot image from the network server, which is then transmitted to the new client. The client installs the boot image only after validating it or the server using the authentication data from the portable medium. Future software updates to the network client may also be handled in a similar manner.

In additional embodiments, the authentication data on the portable medium may be used to authenticate the network client to the network server and establish secure communications there-between. The portable medium or hardware token may also contain an identifier that is communicated to the network server, which determines the network boot image that is to be served to the network client. Future software upgrades of the client may be handled in a similar manner.

### BRIEF DESCRIPTION OF THE DRAWINGS

Further aspects of the present disclosure will be more readily appreciated upon review of the detailed description of its various embodiments, described below, when taken in conjunction with the accompanying drawings, of which:

FIG. 1 is a diagram of an exemplary computer network according to the present disclosure; and

FIG. 2 is an exemplary network boot and mutual authentication process performed over the computer network of FIG. 1.

### DETAILED DESCRIPTION OF THE SPECIFIC EMBODIMENTS

Prior approaches to automate bootstrapping and make it more intuitive to use are highly insecure. Such approaches typically have new devices come up in an impressionable state, in which they will accept commands and configuration information from the first device they encounter over the network that decides to offer it to them.

In contrast to prior methods, a secure approach is introduced herein for automatic discovery, configuration and updating of new client machines on a computer network. In particular, many computing devices, such as personal computers (PCs) now come with the ability to access passive USB storage devices, portable, computer-readable media, and other hardware tokens at the lowest levels of their firmware or Basic Input/Output System (BIOS). This allows such media or hardware tokens to be used as boot devices. By taking advantage of this capability, a secure initialization of a new machine onto a computer network can be achieved by extending prior network boot protocols.

The security requirements for such extended protocols can be described simply. First, each client must be able to authenticate a server from which it is receiving updates and configuration commands. Second, each server should be able to authenticate individual clients, to ensure that the correct client receives the correct commands and data, and that no unauthorized client receives sensitive data. Finally, in order to prevent attackers from altering or eavesdropping on potentially sensitive communications between servers and clients, the processes introduced herein that allow servers and clients to mutually authenticate may also allow them to secure their subsequent communications.

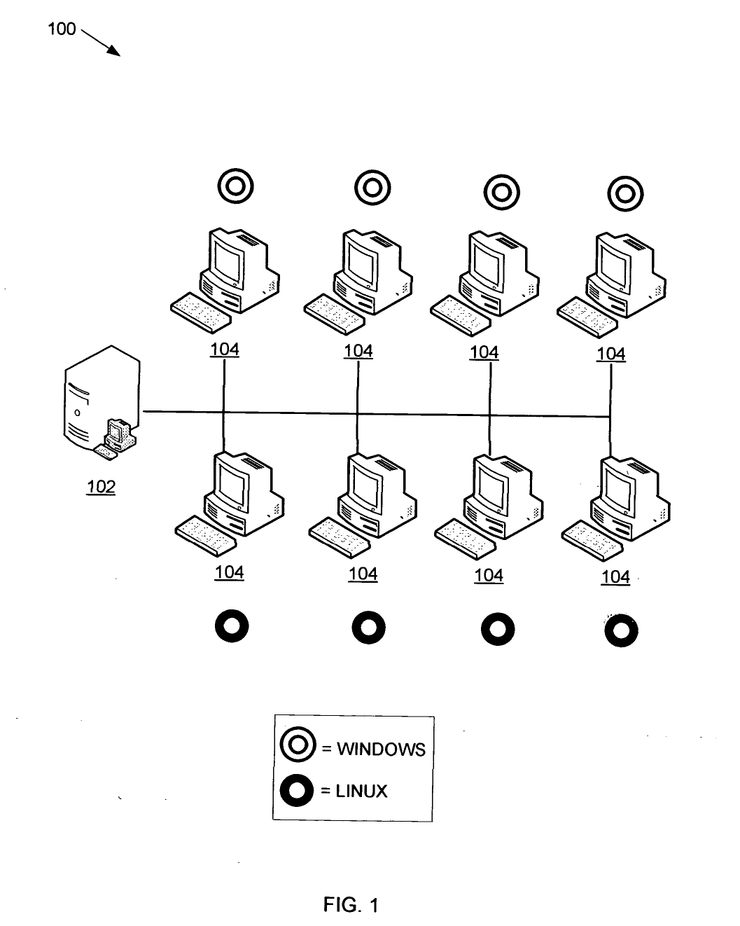

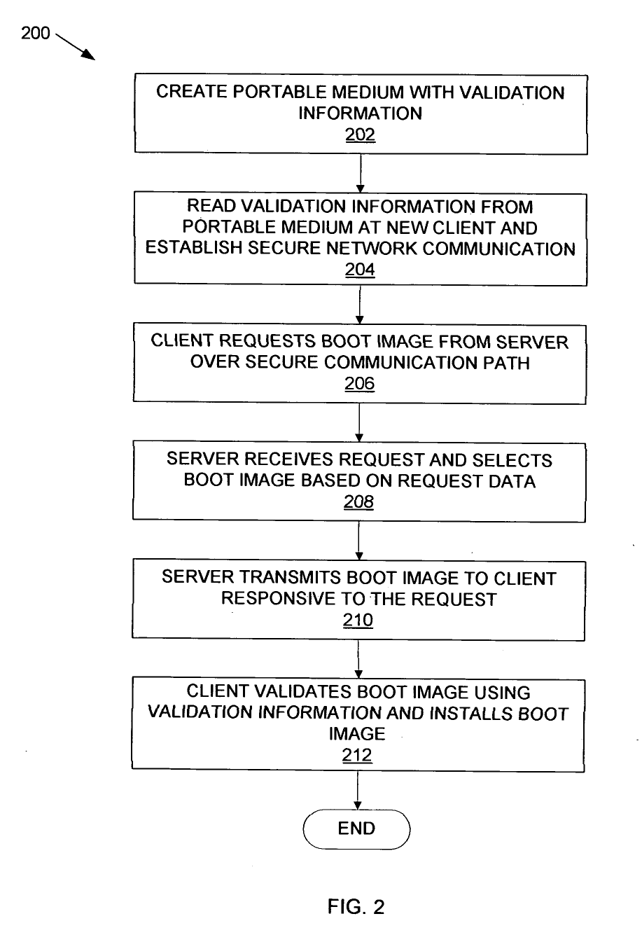

Referring now to FIGS. 1-2, wherein similar components of the present disclosure are referenced in like manner, various embodiments of a hardware-supported secure network boot process are disclosed.

Turning now to FIG. 1, there is depicted an exemplary computer network 100, which includes a network server 102 and a plurality of network client terminals 104. It is readily contemplated that computer network 100 may be any type of network over which computer data and instructions may be transmitted, including but not limited to, a local area network (LAN), a wide area network (WAN), a corporate intranet, a fiber optic network, a wireless network, or any combination or interconnection of the same. The computer network 100 is also not necessarily restricted to the number of components, or their manner of interconnection, as shown in FIG. 1. The computer network 100 may also include various effective and well-known security measures, such as encryption and secure transmission protocols, to securely communicate data.

The network server 102 may be any type of suitable computing device, including, for example, an enterprise network server of the type commonly manufactured by SUN MICROSYSTEMS or IBM CORPORATION, and having a processor and memory for storing and executing processing instructions necessary to complete the functions described herein. The network server 102 may also be a group of distributed servers rather than a single server as shown in FIG. 1.

The client terminals 104 may be any type of computing device that can communicate with the network server 102 over the computer network 100, in order to accomplish the functions described herein. Accordingly, such client terminals 104 may each be a PC, a desktop, palmtop, laptop or notebook computer, a workstation, a wireless computing device, or the like, each of which may operate under a variety of known operating systems.

Referring now to FIG. 2, therein is depicted a flowchart of an exemplary network boot process 200 that may be performed over the computer network 100 of FIG. 1. The process commences at step 202, where an administrator (or other party responsible for the introduction of new client machines to the computer network 100) creates a portable medium or hardware token for use by a client machine to request and validate a boot image upon initial connection to the computer network 100.

In various embodiments, the administrator uses management software or the like to store data on one or more such portable media or hardware tokens for use in securely initializing new network clients. The management software may allows the administrator to store data on several types of such media or tokens and specify or associate one of a plurality of available boot images that are to be provisioned to client terminals 104 based on the type of data written to the media or token. For example, one type of media may be created to install Linux OS, while another type may be for installations of a WINDOWS OS. This functionality can be completely predetermined by an administrator of the computer network 100.

The portable media or hardware token may be any of the following: compact discs (CDs), mini-CDs, digital versatile discs (DVDs), Uniform Serial Bus (USB) devices, floppy diskettes, or other media or devices that may be placed into communication with a client server to provide computer-readable information required for secure boot.

The portable medium or hardware token will be referred to hereinafter collectively as a token, and may, in various embodiments, contain the following types of data stored thereon, as may be determined appropriate by an administrator: (a) an authentication token, such as a public key, for use in encrypting/decrypting data from the server 102 or establishing a secure communication path in any of a variety of known handshake protocols; (b) a unique identifier (ID) comprising a string of characters (e.g., a random secret value, a password, or a signed time-stamped message) that may be transmitted for identification purposes to the server 102 with the request for a boot image, or used by the client terminal 102 to validate data received from the server 102; (c) authentication information for the server 102, for example, a digest of its public key, its network address or its Internet address, for use by the client terminal 104 to authenticate the server 102; (d) programming instructions including which operating system and applications to install upon boot; and (e) a hash or other combination of any of these types of data.

In some embodiments, the token could contain a network boot “stub” or bootstrapping code that a new client terminal 104 could use to obtain, and verify a boot image subsequently obtained over the network, in a process that could optionally include authentication of the client terminal 104 by the server 102.

Continuing with the process 200, the administrator may then take the token and physically plug it into a new client terminal 104. Upon booting the terminal 104, it reads the data stored on the token (step 204) and generates a request for a boot image from the network server 102 (step 206).

In certain embodiments, the new client terminal 104 may use a public key on the token to establish a secure data communication with the server 102. For example, the new client terminal 104 may employ a secure variant of BOOTP or TFTPBOOT, tunneled over secure sockets layer/transmission layer security (SSL/TLS) or some other secure protocol. The client may optionally authenticate the server 102 by determining that the public key the server 102 uses to establish the SSL connection, or to encrypt data, matches the authentication data stored on the token.

In certain embodiments, the client terminal 104 may provide a secret value stored on the token with the request to the server 102 for identification, validation or authentication purposes.

Returning to the process 200, the server 102 receives the network boot image request and selects a boot image to serve to the new client terminal 104 based on the request or data contained within the request (step 208). In certain embodiments where the request contains a value from the token for identification purposes, the server may select the type of boot image to serve based on the received value, using stored associations of values to various types of available boot images as established by the administrator. In certain additional embodiments, the server 102 may authenticate the new client terminal 104 by requesting and receiving the secret value stored on the token.

Next, at step 210, the server 102 transmits an appropriate boot image to the new client terminal 104 responsive to request (step 210). The client then receives the boot image and installs the same (step 212), after which the process 200 ends. In one variation of step 212, the new client terminal 104 may authenticate the boot image itself using data stored on the token. In certain additional embodiments, the new client terminal 104 could follow a sequence of update commands present on the token itself, obtaining only certain data from the server 102.

We note that the tokens can be later re-used to install/upgrade new operating systems and software, in a manner similar to the process 200. Additionally, once a client terminal 104 has been initialized, future updates of this form can occur either with or without the presence of a token, since both client and server may contain information necessary to authenticate one another after the initial boot. For high-security applications, the presence of a physical interlock token containing an additional authenticator value (such as a previously committed to secret value, a password, or a signed time-stamped message) could be required as a physical “go” signal to trigger necessary updates.

Some additional variations of the process 200 will now be presented. For instance, in some cases, server authentication of the client terminal 104 may not be required, at the discretion of a network administrator. In such cases, the process 200 can be simplified by removing any authentication code stored on the portable medium used for authenticating the client terminal 104 to the network server 104. Instead, a freely-available boot image with no sensitive data may be delivered to all machines on the computer network 100. However, data used for server authentication remains important in such embodiments to prevent the possibility of client terminals 104 downloading unauthorized boot images.

Another variant of the process 200 involves providing a boot image to a client terminal 104 over the computer network 100 that is digitally signed by a recognizable public key. This public key, which may be a certificate containing the public key, a hash of the public key, or a hash of a certificate, may be stored on the token in order to validate a boot image offered by the server 102 to the client 104, upon initial connection to the computer network 100.

In various embodiments, the client terminal 104 may never write to the token during its initial configuration. Therefore, a read-only medium, such as a compact disc or digital video disc, may be used in place of a re-writable medium. This may be advantageous for client terminals 104 that do not have the BIOS support required to use a hardware token as a boot device. In other instances, the client terminal 104 may write identification data (such as a media access control (MAC) address to the token, which may later be read by the server 102 to confirm the authenticity of the network client 104.

Furthermore, client terminals 104 with long-term memory accessible by BIOS at boot time could cache keying material from the token for use in subsequent secure network boot protocol executions. Using this technique, the presence of the token is required only on the first boot. This, however, may increase the risk of compromising client authentication, since the BIOS of client terminals 104 would contain valuable secrets that could allow an attacker to impersonate a legitimate client.

In further embodiments, an administrator of the computer network 100 may maintain control of the process 200 using network management software at the network server 102 or another client terminal 104. Such an approach, while requiring manual interaction with individual client terminals 104, may not be appropriate for extremely large networks, but is extremely intuitive and highly secure.

Finally, the process 200 may, in certain embodiments, employ a “leap-of-faith” trust assumption in which the very first boot of a client terminal 104 requires that it exchange keying material with the network server 102 during initial boot, which is then put in long-term storage on the client terminal 104 for subsequent network boots. This is not the same as previous impressionable boot techniques in that only the first boot is impressionable and subsequent boots are secured using data exchanged on the first boot.

Although the best methodologies have been particularly described in the foregoing disclosure, it is to be understood that such descriptions have been provided for purposes of illustration only, and that other variations both in form and in detail can be made thereupon by those skilled in the art without departing from the spirit and scope thereof, which is defined first and foremost by the appended claims.

What is claimed is:

1. A method for securely configuring clients on a computer network, comprising:
generating validation data on a token;
reading the validation data from the token at a network client;
establishing a secure connection between the network server and the network client during an initial connection to a computer network, using the validation data
transmitting, from the network client to a network server, a request for a boot image;
selecting, at the network server, a boot image responsive to the request;
transmitting the boot image from the network server to the network client;
validating the boot image at the network client using the validation data from the token; and
installing the boot image at the network client, after said validating.

2. A method for initializing a network connection with a new client, comprising:
storing, on a portable medium, data for use in provisioning a boot image for network clients;
receiving a request for a boot image from a new network client having the portable medium; and
transmitting the boot image to the new network client in a format for validation by the network client using the data on the portable medium.

3. The method of claim 2, the portable medium comprising at least one of:
a Universal Serial Bus (USB) device, a compact disc (CD), a mini-CD, and a floppy diskette.

4. The method of claim 2, the data comprising at least one of:
a public key, a secret value, and a hash of the public key and the secret value.

5. The method of claim 2, further comprising:
authenticating the new network client when the new network client provides the data from the portable medium.

6. The method of claim 2, further comprising:
establishing a secure network connection with the new network client using the data.

7. The method of claim 2, said transmitting further comprising:
receiving the data from the new network client with the request; and
selecting the boot image from a plurality of stored boot images based on the data.

8. The method of claim 2, further comprising:
selecting a software update for the new network client based on the boot image; and
transmitting the software update to the new network client, wherein the new network client validates the software update using the data on the portable medium.

9. A method for securely configuring a network client of a computer network, comprising:
receiving a boot image request from a network client, the boot image request including data stored on a portable medium read by the network client;
selecting a boot image for the network client based on the data stored on the portable medium; and
transmitting the boot image to the network client.

10. The method of claim 9, wherein the network client validates the boot image using the data stored on the portable medium.

11. The method of claim 9, further comprising:
maintaining a plurality of boot images available for new clients; and said selecting further comprising:
selecting the boot image from the plurality of boot images.

12. The method of claim 9, further comprising:
authenticating the network client based on the data.

13. The method of claim 9, further comprising:
establishing a secure network connection with the network client using the data.

14. The method of claim 9, further comprising:
transmitting a software update to the network client, wherein the network client validates the software update using the data stored on the portable medium.

15. A method for securely initializing a connection to a computer network, comprising:
reading authentication data stored on a token;
requesting a boot image from a network server during an initial connection to a computer network;
receiving the boot image from the network server;
validating the boot image with the authentication data; and
installing the boot image responsive to said validating.

16. The method of claim 15, said requesting further comprising:
reading identification data from the token; and
providing the identification data to the network server, wherein the network server selects the boot image from a plurality of available boot images based on a stored association of identification data with the boot image.

17. The method of claim 15, further comprising:
establishing a secure data connection with the network server using the authentication data.

18. The method of claim 17, further comprising:
encrypting the secure data connection using the authentication data.

19. The method of claim 15, further comprising:
receiving a software update from the network server;
validating the software update with the authentication data; and
installing the software update.

20. The method of claim 15, wherein the network boot image is not installed when the boot image is not validated by the authentication data.
